(19) United States
(12) Patent Application Publication
(10) Pub. No.: US 2001/0034723 A1
(43) Pub. Date: Oct. 25, 2001

(54) System and method for providing anonymous internet transactions

(76) Inventor: Arun K. Subramaniam, Plymouth, MN (US)

Correspondence Address: David R. Fairbairn, THE KINNEY & LANGE BUILDING, 312 South Third Street, Minneapolis, MN, 55415-1002, US

(21) Appl. No.: 09/781,748

(22) Filed: Feb. 12, 2001

Related U.S. Application Data
(60) Provisional application No. 60/182,091, filed on Feb. 11, 2000.

(51) Int. Cl. G06F 17/60; H04K 1/00; H04L 9/00

(52) U.S. Cl. 705/74; 705/26

(57) ABSTRACT

A privacy agent programmatically monitors and maintains transactional anonymity between users on an Internet web site. Each user on the web site is required to provide identifying information to establish an account on the web site. The identifying information is validated before the account is generated. Then, users are permitted to post messages on the web site to initiate and to negotiate transactions. Initial messages may be viewed on a public message board, while responses and subsequent message interactions are posted to a private area. All messages are monitored programmatically to prevent unauthorized disclosure of a an actual identity of a user. Each user is permitted to gradually reveal an actual identity to other users through private message postings.

CROSS-REFERENCE TO RELATED APPLICATION(S)

The present application claims priority from Provisional Application Ser. No. 60/182,091 filed Feb. 11, 2000, entitled “Computerized System with Means for Maintaining Anonymity”.

### BACKGROUND OF THE INVENTION

The present invention relates to a method for providing anonymous Internet transactions, and more particularly, to a method and system for allowing real-time, anonymous negotiations over the Internet.

The growth of the Internet has led to a number of benefits in the ease with which individuals can research, find, and purchase items. The Internet facilitates transactions, permitting Internet users to communicate over long distances in various forms, including text, images, sound, video, etc. With the growth of the Internet and the increasing numbers of mechanisms for exchanging information or for buying and selling products, protection of user information has become increasingly important.

Whether an Internet user posts an item for sale on an auction website or registers on an online bulletin board or even registers for access to a chat room or instant messaging service, typically a user is required to register an account with the service provider. Registering an account typically requires a user to provide identifying information, such as a first name, a last name, an address, an e-mail address, and a telephone number.

Depending on the type of service, account information is treated with varying levels of secrecy. Typically, on auction sites for instance, since users register accounts using their credit card, their account information is kept strictly confidential. All transactions between users on their sites typically are brokered by the site, to allow the provider to exact a transactional fee in the event of a sale.

On web sites where users post comments but do not transact other types of business, the service provider may make no effort to verify the account information and no effort to conceal the information. Any user may then look up the account information for another user.

In this instance, a user who is Internet savvy might register an account by providing fictitious information regarding the user's actual identity so as to provide a virtually impenetrable level of protection. In the event that such a registered user misuses the bulletin board site unlawfully, such as by posting illegal pornographic images, it may be extremely difficult to assist law enforcement in apprehending the person. If the user has provided fictitious information, determining the user's actual identity may be impossible.

On still other bulletin board sites, the identity of a user may be kept completely anonymous. Users who register an account with the web site may feel free to include correct information without concern that their information will be revealed. Other users who wish to learn more about the registered user will only be able to obtain the creation date of the account. Typically, such a site makes no preemptive effort to prevent disclosure of a user's identity. Once a message is posted that contains identifying information, it may be taken down. However, such a disclosure generally cannot be perfectly retracted as others may have viewed the information before the message was removed

There is a need on the Internet for website for anonymous transactions that passively permits users to negotiate transactions on the site while actively preventing inadvertent disclosure of identifying information to the other party.

### BRIEF SUMMARY OF THE INVENTION

A privacy agent programmatically monitors and maintains the anonymity of transactions between two registered users on a secure system. The system automatically validates the account information for each user. Once a user successfully registers an account, the system permits the user to view and post messages on the system. Each message posted to the system passes through the privacy agent to prevent the inadvertent disclosure of identifying information by warning the user of the disclosure and requiring the user to authorize the disclosure before posting the message. Each party may instruct the privacy agent to permit the disclosure of identifying information.

### BRIEF DESCRIPTION OF THE DRAWINGS

FIG. 1 is a block diagram of the system of the present invention.

FIG. 2 is a flow diagram of the registration process of the present invention.

FIG. 3 is a flow diagram of a client posting a new transaction on the system of the present invention.

FIG. 4 is a flow diagram of the privacy agent of the present invention.

FIG. 5 is a flow diagram illustrating the marketing options available for a new transaction.

FIG. 6 is a schematic flow diagram of a registered prospect interaction with the system of the present invention.

FIG. 7 is schematic flow diagram of the creation of a new transaction on the system of the present invention.

FIG. 8 is a block diagram showing an overall layout of a system with multiple servers and databases.

FIG. 9 is an illustration of sample client information stored in an account record in the data store together with an associated status flag.

FIG. 10 is a schematic flow diagram of an embodiment of the privacy agent using the status flag and account information of FIG. 9.

### DETAILED DESCRIPTION

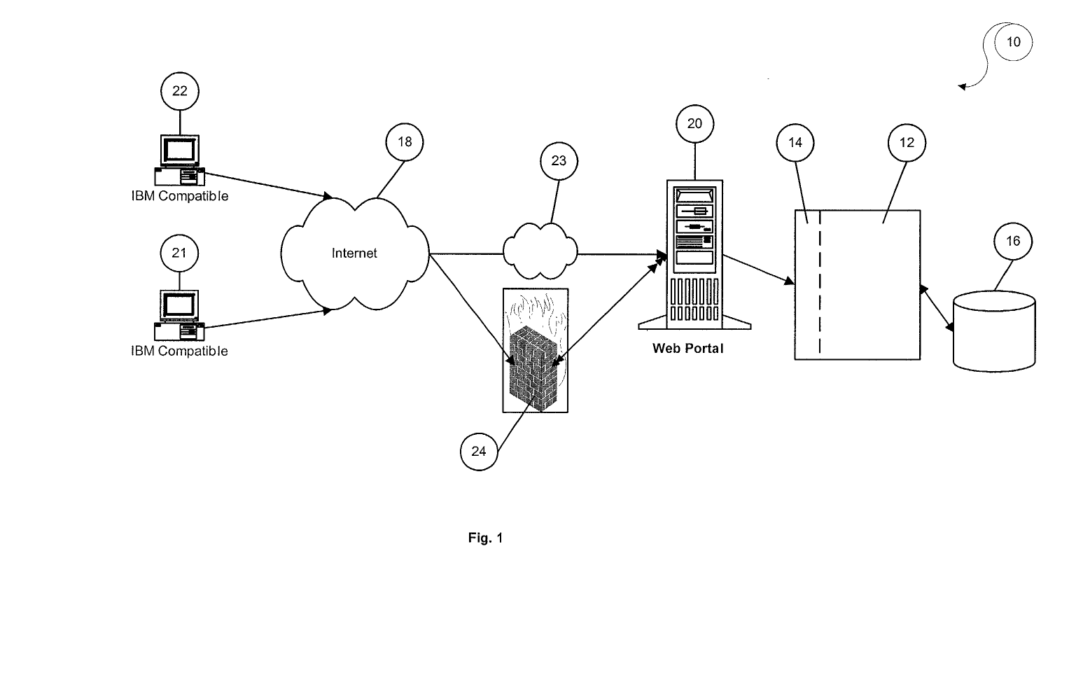

An anonymous, Internet-based transactional system 10 of the present invention generally includes a web server 12, a privacy agent 14, and a data store 16, which are connected to the Internet 18 via a web portal 20. The web server 12 provides a web page interface for prospects 21 and clients 22 on the Internet 18. As shown in FIG. 1, a prospect 21 and a client 22 interact with the web server 12 through the web portal 20.

The web server 12 is a secure server, which does not permit unauthorized access. The web server 12 provides a web interface, which is accessible to all Internet users. This web interface provides various options and information about the web site. However, the web server 12 uses a privacy agent 14 to filter transactions between Internet users. To effectively filter transactions, the web server 12 categorizes Internet users into two categories: prospects 21 and clients 22.

Initially, the transactional system 10 categorizes all Internet users as potential prospects. A potential prospect is any person who visits the website interface, who might be interested in a transaction, or who simply browses the Internet 18. The prospect 21 may be attracted to the website via advertising, stickers, announcements or any other means. The web server 12 provides a web page interface for all potential prospects. The web page interface contains multiple options from which the potential prospect can choose, including registering on the web server 12. A potential prospect becomes a prospect 21 by registering on the web server 12 to respond to an existing transaction.

A transaction may be an advertisement for the sale of an item, a personals ad, an employment opportunity, any type of transactional offer, or any initial informational posting. Transactions may be pictorial, graphic, audio, video or text. The web server 12 stores all transactions in the data store 16 and provides a web interface for any potential prospect to view all transactions on a public bulletin board 23.

An Internet user becomes a client 22 by registering on the web server 12 to post a new transaction, which may then be viewed by potential prospects. The web server 12 does not accept new transactions or responses from potential prospects. Internet users must be registered as either clients 22 or prospects 24 before the transactional system 10 will permit interaction beyond simply viewing posted transactions.

Generally, the client 22 and the interested prospect 21 will communicate via text messages posted to a private bulletin board 24 on the web server 12. While the transactional system 10 is capable of permitting posting of images, sound, video, in the preferred embodiment, communications will be in a text format, to limit the memory space required to store each message in the data store 16 and to facilitate the automated review of the messages by the privacy agent 14. Furthermore, as the transactional system 10 is geared toward anonymous interaction, the identity of the client 22 and the prospect 21 are guarded by the privacy agent 14 to prevent inadvertent or unauthorized disclosure of their identities.

Each message posted to the web server 12 will pass through the privacy agent 14. The privacy agent 14 may be located on the web server 12, on the server acting as the web portal 20, or on any other computer in network communication with the web server 12. The privacy agent 14 automatically intercepts and reviews all message traffic between the web portal 20 and the web server 12. The privacy agent 14 automatically reviews each message to verify that identifying account information has not been inadvertently revealed in the message.

The web server 12 presents web pages dynamically to each prospect 21 and each client 22. Though conceptually the messages can be considered as posted on a bulletin board, the web server 12 stores the messages in its data store 16, and presents them to authorized clients 22 and prospects 21. Thus, conceptually, there is a public bulletin board 23 and a private bulletin board 24, such that initial posted messages are served to all Internet browsers via the public bulletin board 23, but subsequent messages can be viewed only on the private bulletin board 24 by the client 22 and the prospect 21 who are directly involved in the negotiations. The private bulletin board 24 is accessible to only that prospect 21 and that client 22. After the initial client 22 posting, all subsequent posting between the client 22 and the prospect 21 remain inaccessible to other users, even after the negotiations have run their course. Thus, the negotiations or conversations between the prospect 21 and the client 22 are private.

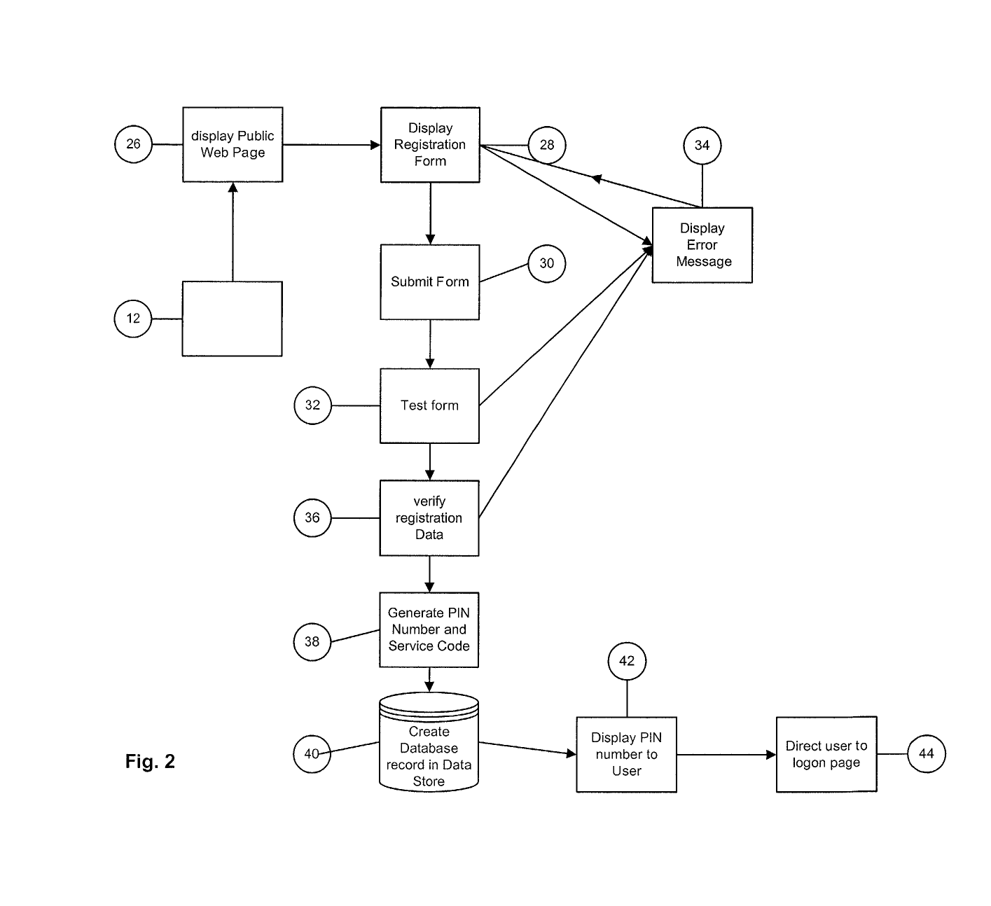

As shown in FIG. 2, the web server 12 displays a public web page (step 26) for a potential prospect. If the potential prospect chooses to register by clicking on a link on the public web page, the web server 12 displays the registration form and waits (step 28) for the potential prospect to complete the registration form. The registration form requires identifying information from the potential prospect. Specifically, the form requires a first name, a last name, an address, and a credit card number. In addition, the registration form permits a potential prospect to check a box in order to post a new transaction or offering.

When the potential prospect has completed the form by entering the required information, the potential prospect clicks a button on the website interface to submit the form (step 30). Submitting the registration form (step 30) can be completed by clicking a link or a button, or by any other known web protocol effecting submission of a form.

The system 10 programmatically tests the completed registration form (step 32) to verify that the potential prospect has completed all of the required fields. Testing may be performed at the web page level using ActiveX controls, Javascript, etc., or it may be performed by the web server 12. Required fields may include the first and last name, the address, and the credit card number. Since the registration data includes credit card information, the registration screen is secured by the web portal 20, or by a firewall (not shown). An administrator of the web site can require additional fields, simply by modifying the page level controls or scripts or by changing web server requirements, depending on how the method is implemented. If the potential prospect left out required information, the web server 12 displays an error message (step 34), and then displays the registration form and waits (step 28) for the potential prospect to complete the registration form.

If the potential prospect completed all of the required fields, the system 10 verifies the registration data (step 36) using the credit card number. In the preferred embodiment, the system 10 verifies the registration data (step 36) by charging a transaction fee to the credit card number. If the box on the registration form is checked indicating that the potential prospect is initiating anew transaction, the transaction fee is greater than zero. If the box is not checked, the transaction fee equals zero dollars ($0).

For both the client 22 and the prospect 21, the system 10 uses the credit card number to validate or verify the registration data (step 36) as a protection against fictitious registrations. If the user attempts to register using fictitious information or incorrect information in the user's registration, the credit card transaction will fail, and the account will not be created. Additionally, clients 22 will be billed for use of the system; however, prospects 21 may view transactions and post responses without being charged. Thus, for the prospects 21, the credit card information is used solely for validation of the actual identity of prospect 21. The zero dollar transaction fee serves to verify the registration data represents the actual identity of the potential prospect.

If the credit card transaction fails, the web server 12 displays an error message (step 34), and then returns the potential prospect to the registration form and waits (Step 28). If the credit card transaction succeeds, the web server 12 generates a pin number and a unique service code (step 38) and creates a database record (step 40) for the registration information, the pin number, the unique service code, and the registered user's category (i.e. client 22 or prospect 21) in the data store 16. The registration information for both prospect 21 and the client 22 is stored in the data store 16. The data store 16 maintains all account information and all transactions for each registered user on the web server 12.

Then, the web server 12 displays the pin number (step 42) in the user's browser window. After registering, when a client 22 or a prospect 21 visits the web server 12, the client 22 and the prospect 21 must enter the pin number to logon to the system 10. The system 10 uses the pin number as an identifier for a user, such that messages and responses are linked to the user via a pin number. Finally, the web server 12 directs the user to the transaction page (step 44).

In an alternative embodiment instead of displaying the pin number to the user as shown in step 42, the system 10 may e-mail the pin number to the user as an additional layer of protection. If the user provides a fictitious e-mail address, the pin number will not be delivered, and the system 10 can inactivate the registration. However, in the preferred embodiment, the registration process takes only a few seconds, and the system 10 will display the pin number as indicated in step 42.

In the preferred embodiment, the account registration form will request additional, optional information, such as nicknames, employer name, work address, work phone number, and e-mail addresses, etc. This additional information will be used by the privacy agent 14 of the transactional system 10 to prevent inadvertent disclosure of identifying information.

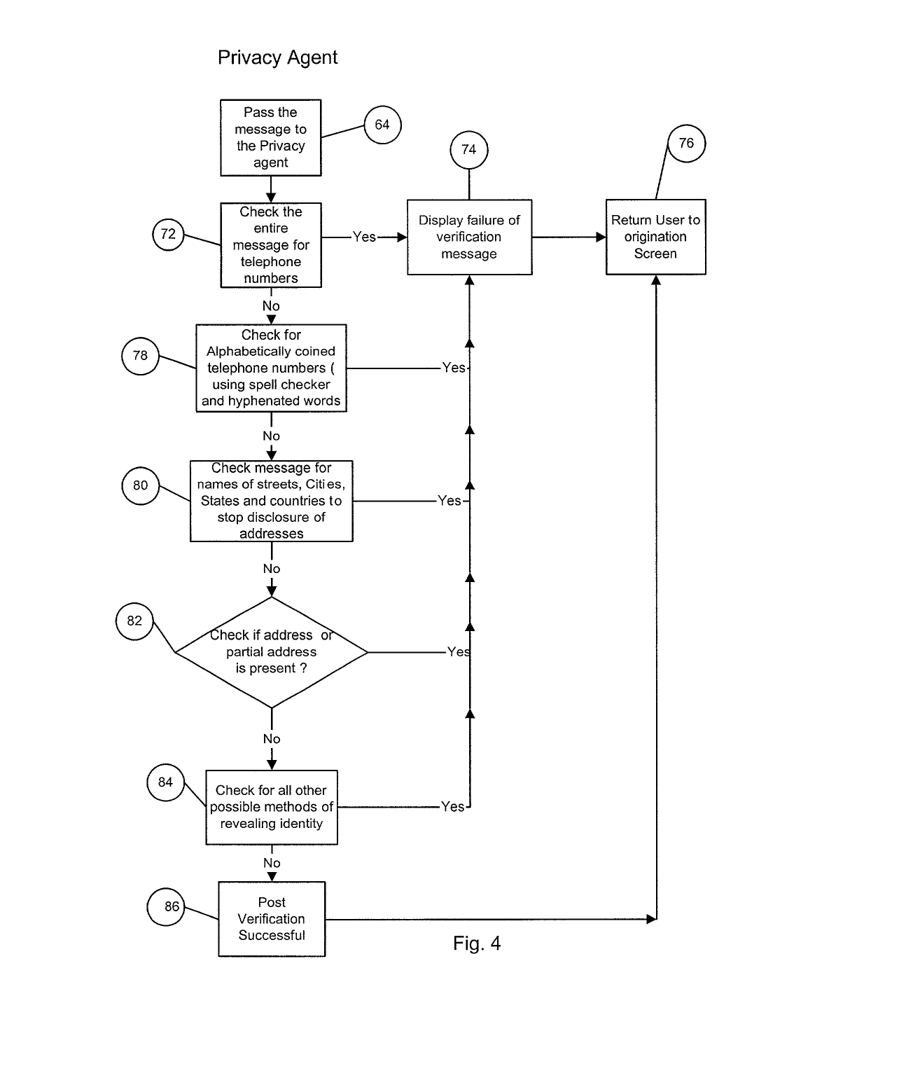

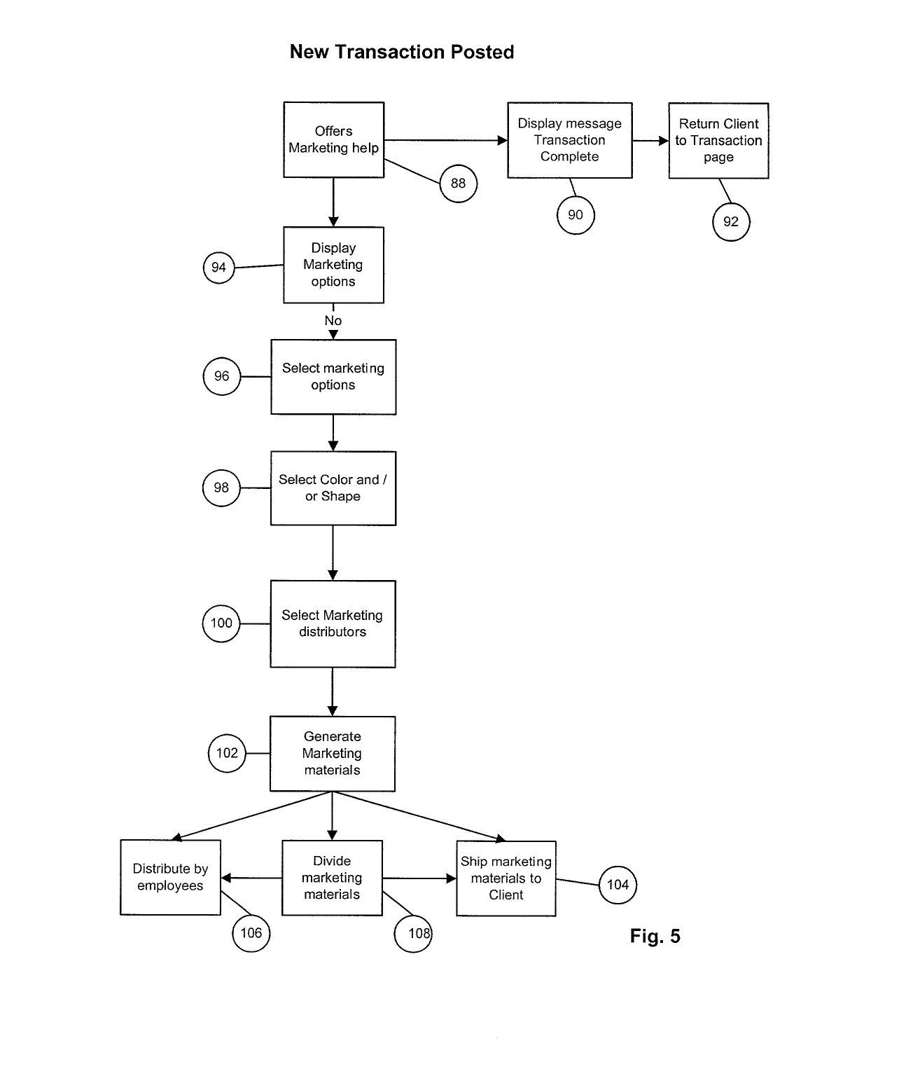

Identifying information maybe a name, a city, an e-mail address, or any personal information that serves as a clue to a user's actual identity. The system 10 uses a privacy agent 14 to protect a user from inadvertent disclosures of such identifying information. The details will be described later with respect to FIGS. 4 and 5.

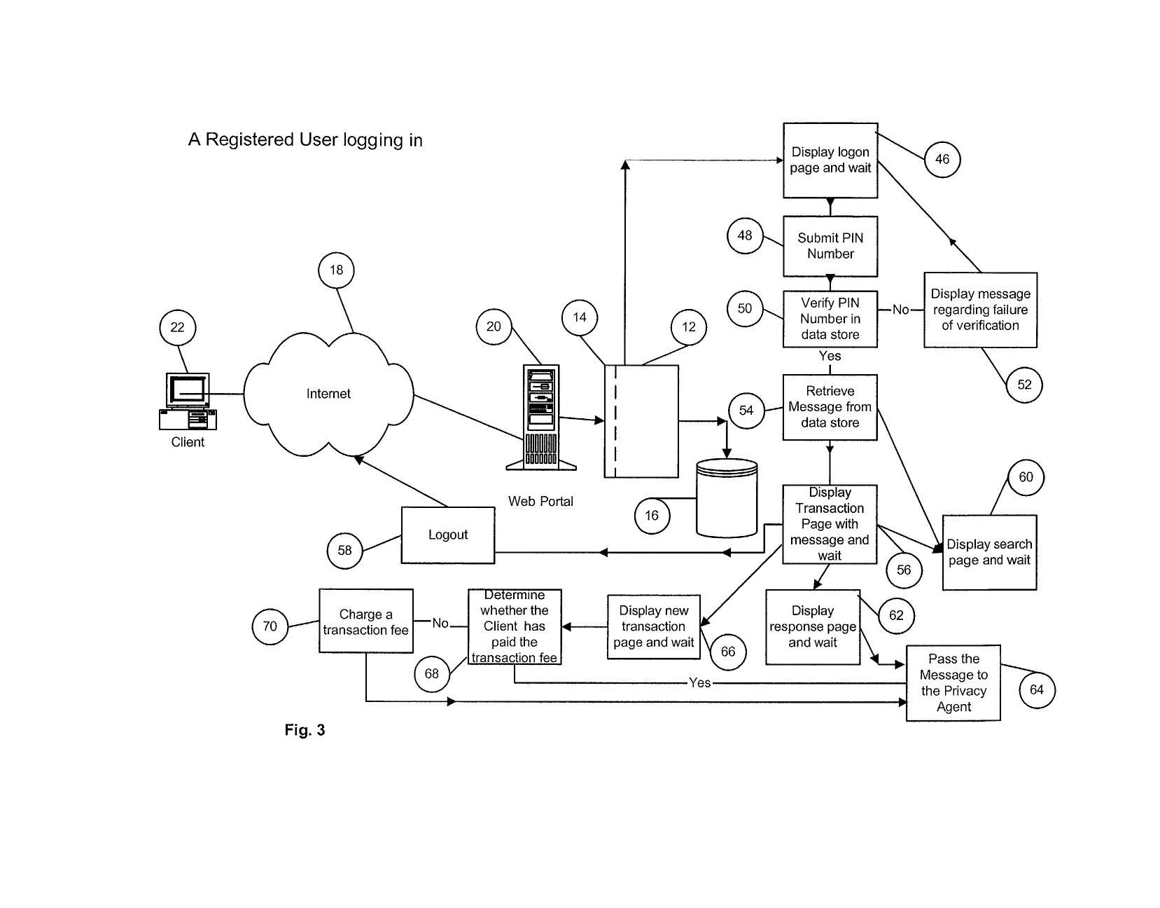

As shown in FIG. 3, when a client 22 wishes to logon to the web server 12 over the Internet via web portal 20, the web server 12 displays the logon page and waits (step 46) for the client 22 to submit the pin number (step 48). The web server 12 verifies the pin number (step 50) against the records in the data store 16. If the web server 12 cannot verify the pin number, the web server 12 displays a failure message (step 52), then displays the logon page and waits (step 46). If the web server 12 successfully verifies the pin number, the web server retrieves messages (step 54) intended for the client from the data store 16. Then, the web server displays the transaction web page with the retrieved messages and waits (step 56) for the client to choose the next course of action.

When a prospect 21 wishes to logon to the web server 12 over the Internet 18 via web portal 20, the same method shown in FIG. 3 applies. In other words, the web server 12 and the prospect 21 interact in the same method as previously described with respect to the client 22 logging on to the web server 12.

At this point, the web server 12 provides several options for the client 22. The client 22 can logout, search posted messages, respond to a messages, or post a new transaction. If the client chooses to logout, the web server 12 displays a logout screen and returns the client to the main web page (step 58) on the Internet 18. If the client 22 chooses to search transactions, the web server 12 directs the client to a search page and waits (step 60) for the client 22 to enter the search terms. Once the client submits the search terms, the web server 12 retrieves messages (step 54) according to the search terms, and displays the transaction page with the messages (step 56).

If the client 22 chooses to respond to a transaction, the web server 12 displays a response page and waits (step 62) for the client 22 to enter the text of the response. When the client 22 submits the response, the web server 12 passes the response to the privacy agent (step 64). If the client 22 chooses to post a new transaction, the web server 12 displays a new transaction page and waits (step 66) for the client 22 to enter the text of the new transaction. When the client 22 submits the new transaction, the web server determines (step 68) if the client 22 has paid for the new transaction. If not, the system 10 charges a transaction fee (step 70) to the credit card number of the client 22. If so, the web server 12 passes the new transaction (step 64) to the privacy agent.

All new transactions and all responses pass through the privacy agent 14 (step 64) prior to posting. The privacy agent 14 is generally invoked immediately after the text message is submitted, thereby reviewing the message before it is posted. However, the privacy agent 14 could also be invoked after the message is stored, but before an e-mail notification is sent. In the preferred embodiment, invoking the privacy agent 14 early in the message process prevents unnecessary storage of messages.

FIG. 4 illustrates an embodiment of the privacy agent 14 logic flow. When a response or new transaction is posted to the system 10, the web server 12 passes the message (step 64) to the privacy agent 14. The privacy agent 14 programmatically checks the text of the message for telephone numbers (step 72). If a telephone number is detected, the privacy agent 14 displays a failure message (step 74) and returns the user to the origination screen (step 76).

The origination screen is the web page from which the user initiated the message posting sequence. The system 10 tracks Internet users as they interact with the web server 12, so that if the message fails (step 74) or if the message is posted to the web server (step 86), the web server 12 returns the user to the user to their starting point.

If the web server 12 does not detect a telephone number in the text of the message, the privacy agent 14 checks the message for hyphenated words and “coined” telephone numbers (step 78). “Coined” telephone numbers are words spelled out using the letters on the telephone keypad. If a “coined” telephone number is found, the web server will display a failure message (step 74) and return the user to the origination screen (step 76).

Next, the privacy agent 14 checks the text of the message for identifying information (step 80) such as city, state, street names, address information. If the privacy agent 14 finds identifying information, the privacy agent 14 checks the identifying information for partial address information (step 82). In other words, the privacy agent 14 compares the city, street, or other information relates to a registered user's account information. If the privacy agent finds a match (partial or complete), the web server 12 displays a failure message (step 74) and returns the user to the origination screen (step 76).

If the privacy agent does not find a match, the privacy agent checks the text of the message for other possible revealing information (step 84), such as by testing the message against account information or testing for nicknames. If the privacy agent 14 detects a disclosure, the web server 12 displays failure message (step 74) and returns the user to the origination screen (step 76). If no disclosure is detected, the privacy agent posts the message (step 86). Thus, the privacy agent 14 programmatically prevents a user from disclosing information to another user on the system 10.

In an alternative embodiment, at each failure point in the process, before displaying a failure screen, the person will be asked to verify that they wish to disclose the “offending” information. In the preferred embodiment, the privacy agent 14 will retrieve the account information and search for partial matches in the text of the message, and using the “coined” telephone number search, compare any such “coined words” against the account information. Thus, by comparing the text against the validated account information, the privacy agent can protect against inadvertent disclosures of information with fewer “false positives”. A false positive is defined by the system as text that triggers a failure in the privacy agent process even though it does not disclose identifying information about the user.

As shown in FIG. 5, once a new transaction is posted, the system 10 offers assistance (step 88) to the client 22 for marketing the new transaction. If the client 22 chooses not to market the transaction through the system 10, the web server 12 displays a transaction complete message (step 90) and returns the client 22 to the transaction page (step 92).

If the client chooses to market the transaction through the system 10, the web server 12 displays a marketing option page (step 94). The client 22 selects the marketing materials (step 96). The marketing materials consist of flyers, stickers, pamphlets, e-mail text, etc. Next, the client 22 selects the color and shape (step 98) of the marketing materials. The client 22 chooses stickers and/or flyers in various colors (i.e. red, yellow, green, blue, etc.) and in various shapes (i.e. a car, a house, a plant, a star, etc.).

Next, the client 22 selects the marketing distributors (step 100). Generally, the client 22 has the option of self-marketing the transaction, of marketing the transaction through the system 10, or both. Once the client 22 has selected, the system 10 automatically generates the marketing materials (step 102) according to the selections of the client 22. If the client 22 chose to self-market the materials, the system 10 automatically ships the marketing materials (104) to the client 22 for distribution. If the client 22 opted for the system 10 to distribute the marketing materials, employees of the web site distribute the marketing materials (step 106) in prominent locations. Finally, if the client 22 chooses both options, then the system divides the marketing materials (step 108), employees distribute half (step 106) and the system ships half (104).

Whether the client 22 chooses marketing help or not, the system 10 indirectly markets all new transactions. As prospects 21 visit the web server 12, the web server 12 permits prospects 21 and other Internet users to browse and search transactions using key word searches. Thus, the transactions are marketed to Internet users and prospects 21 who are looking for something, simply by virtue of the search capabilities.

Once a client 22 has registered and posted a message to the web server 12, the web server 12 may notify other registered clients 22 and prospects 24 of the new posting via automated e-mails. If the client 22 is selling a small item, the system 10 may automatically generate e-mails to assist in marketing the transaction.

In an alternative embodiment, the client 22 may be prompted to enter text for the flyers and/or the stickers, prior to generating the marketing materials (step 102). If this option is presented, the system 10 passes the text to the privacy agent 14 for review. The privacy agent 14 either rejects the text and returns the client to the editing window for revision, or the privacy agent 14 allows the text and processing continues. These additional steps could be inserted at any point in the marketing process prior to generation of the marketing materials (step 102).

Typically, a sticker or flyer will contain information only identifying a message ID and a website location, attracting visitors to the site for this specific message posted. For example, the sticker might contain the following message:

“Am I your type? Visit http://www.amiyourtype.com/P17429” Obviously, any information may be presented on a flyer or a sticker to attract visitors. The only limitation is the size of the media. A three-inch by three-inch sticker could not contain a thousand words and still remain legible.

Furthermore, if the transaction involves selling a car or some other property, the sticker may be presented in the shape and/or color of the object offered for sale, or other means may be used to attract visitors including a flyer indicating some of the specifications of the object for sale.

In the context of a personal ad, the stickers permit the individual to choose areas of town and locations where individuals who see the stickers are more likely to have similar interests or backgrounds to themselves. The sticker and/or flyers will provide no identifying information about the client 22.

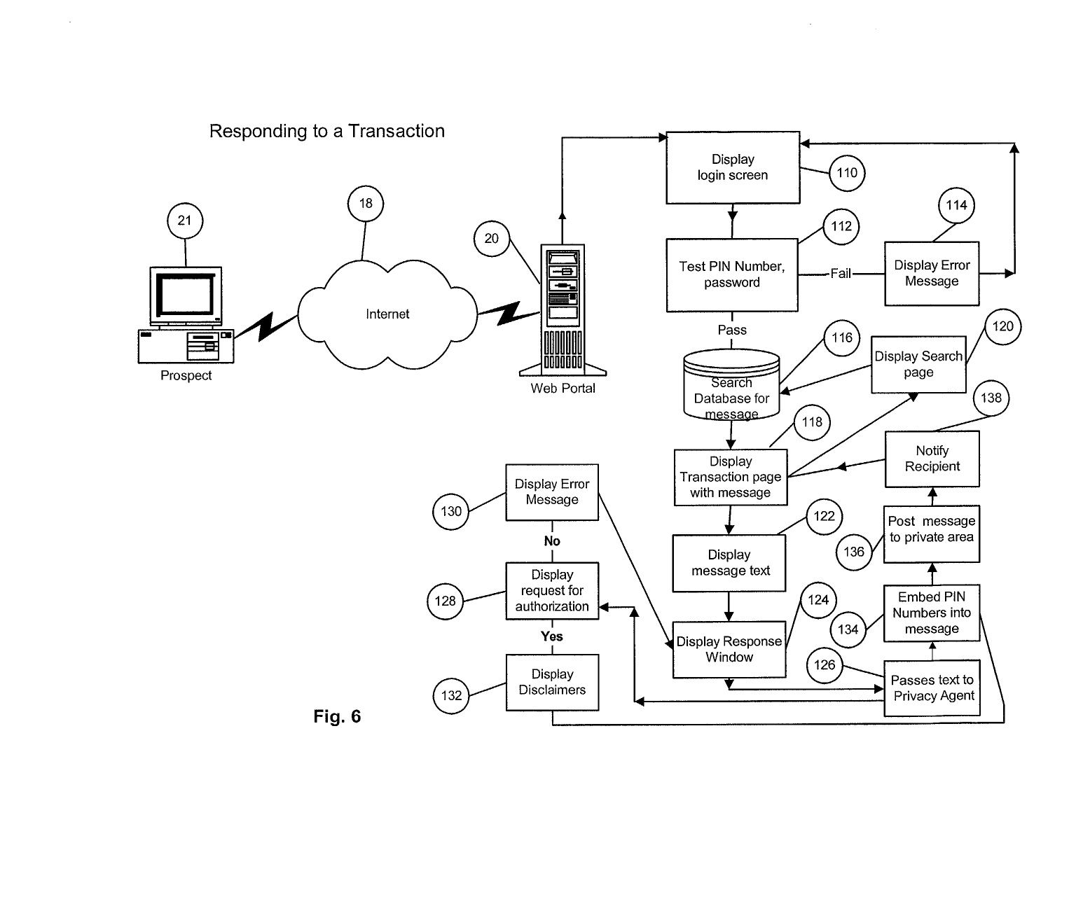

FIG. 6 is a flow diagram of the interaction of a prospect 21 with the transactional system 10. Though the following description depicts the prospect 21 interacting with the transactional system 10, the description is equally applicable to the interaction of a client 22 with the system 10, after the initial transaction has been posted by the client 22.

With regard to FIG. 6, the prospect 21 accesses the web server 12 over the Internet 18 via the web portal 20. The web server 12 displays a login screen and waits (step 110) for the prospect 21 to enter a pin number and password. When the prospect 21 submits the login information, the web server 12 tests the pin and password (step 112) against the records in data store 16. If the login fails, the web server 12 displays a failure message (step 114), and displays the login screen and waits (step 110) for the prospect 21.

If the login succeeds, the web server 12 searches data store 16 for messages (step 116) associated with the prospect 21. Then, the web server 12 displays a transaction page (step 118). If messages were found in step 116, then the messages are displayed in the transaction page (step 118). If no messages were found, the web server 12 displays the transaction page (step 118) indicating that no messages were waiting.

The transaction page typically provides multiple options to the prospect 21, including logging out, creating a new transaction, search transactions, respond to a transaction, etc. In addition, the prospect 21 can review messages if messages were found.

If the prospect 21 wishes to log out, the web server displays the login screen (step 110). If the prospect 21 wishes to search other transactions, the web server 12 displays a search page (step 120), which allows for key word searches. In the preferred embodiment, the system 10 automatically uses the messages retrieved for the prospect 21 (step 116) to offer to search for similar postings. If the prospect 21 enters a keyword and executes a search, the web server 12 searches the database (step 116) and displays the transaction pages with found messages (step 118). If the prospect 21 does not wish to search messages, the web server 12 displays the transaction page (step 118).

In the search option of step 120, the step of searching the data store 16 uses the key words entered by the prospect 21 to perform the search. In the initial search performed immediately after the login, the search on the data store 16 is performed using the pin number of the prospect 21. The pin number is used by the data store 16 to maintain associations between the sender and the intended recipient. Thus, each message stored in the data store 16 contains at least two items of information besides the transaction text: the pin number of the author and the pin number of the intended recipient.

This association is maintained automatically by the system 10. If a client 22 posts a new transaction, the system 10 automatically includes a universal code for the intended recipient. The universal code authorizes all users to view the transaction message. If the client 22 or the prospect 21 is responding to a transaction, the pin number of the prospect 21 or the client 22, respectively, is automatically incorporated with the transaction message to limit access to the message to the author and the author's intended recipient.

If the prospect 21 chooses to view a message, web server 12 displays the message text (step 122). If the prospect 21 does not wish to respond to the message, the web server 12 displays the transaction page (step 118). If the prospect 21 chooses to respond to a message, the web server 12 displays a response page (step 124) and waits. When the prospect 21 submits the response, the web server passes the response (step 126) to the privacy agent 14 to review for disclosures. If the privacy agent 14 detects a disclosure of identifying information, the privacy agent 14 causes the web server 12 to display a request for authorization of the disclosure (step 128). If the prospect 21 chooses not to authorize the disclosure, the web server 12 displays an error message (step 130) and displays the response page (step 124) to allow the prospect 21 to edit the message.

If the prospect authorizes the disclosure (step 128), the web server displays warnings and legal disclaimers (step 132), embeds the pin numbers of the client 22 and the prospect 21 into the message header (step 134), and posts the message to a private area on the server (step 136).

If the privacy agent does not detect a disclosure of identifying information (step 126), the web server bypasses the warnings and legal disclaimers of (step 132), embeds the pin numbers of the client 22 and the prospect 21 into the message header (step 134), and posts the message to a private area on the server (step 136).

Finally, the system 10 notifies the intended recipient that a message is waiting (step 138), before displaying the transaction page with messages (step 1 18). The system 10 may notify the intended recipient (step 138) using any known method including e-mail, wireless pager, facsimile, or any other method. The system 10 may be configured to require a preferred notification method during registration, and the system 10 can use the preferred notification method in step 138.

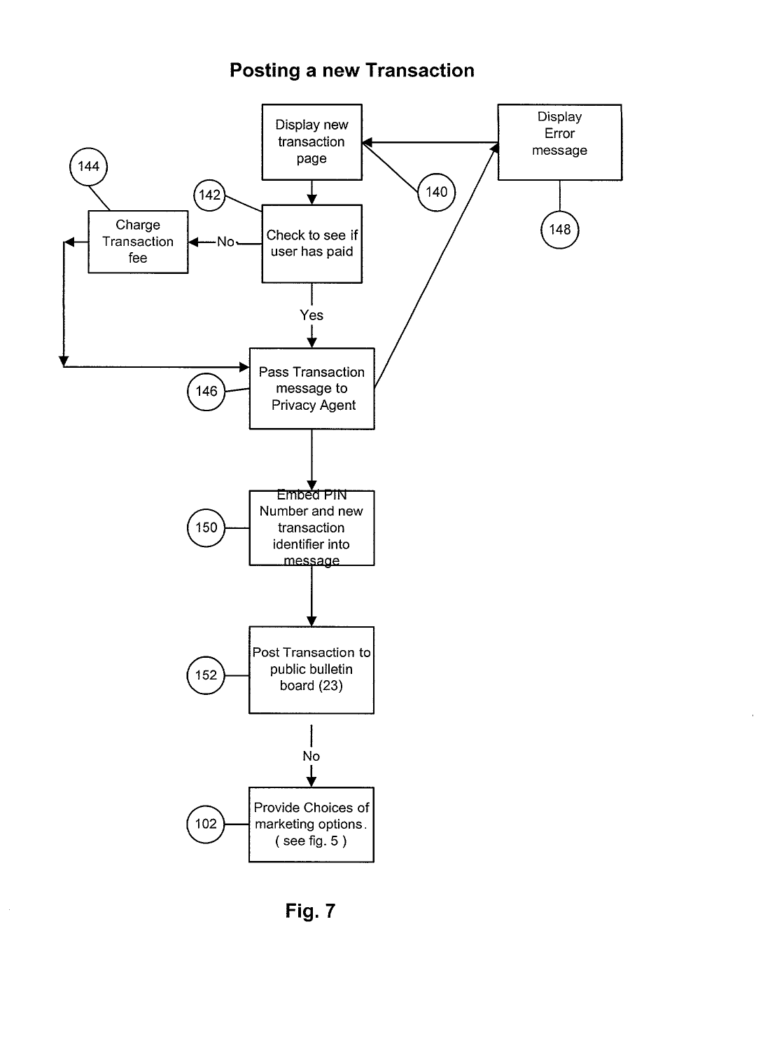

As shown in FIG. 7, if a registered user, i.e. a client 22 or a prospect 21, logs into the system 10 and chooses to initiate a new transaction, the web server 12 displays a new transaction page (step 140). The new transaction page allows the registered user to enter information regarding the transaction. The information may be in the form of images, sound, text, video, etc. In the preferred embodiment, the information is reduced to text to permit the privacy agent 14 to search for disclosures. Thus, if the information is initially presented as an audio message, the system 10 converts the message into text (step not shown) before testing the message.

Once the registered user submits the new transaction, the web server 12 checks to see if the registered user has paid for this transaction (step 142). If the user has not paid, the system 10 charges a transaction fee (step 144) to the user before proceeding. Once the user has been charged (step 144) or if the user has already paid, the system 10 passes the transaction message (step 146) to the privacy agent 14.

If the privacy agent 14 detects a disclosure of identifying information, the web server 12 displays an error (step 148) and displays the new transaction page (step 140) to allow the user to edit the transaction. The user may not disclose identifying information in a new transaction message because new transactions are posted to a public bulletin board 23 on the Internet 18. Thus, if a user tries to post identifying information (such as a phone number, a name, an address, etc.), the system 10 displays an error (step 148) and then displays the new transaction page (step 140) for the user to try again.

If the privacy agent detects no disclosure of identifying information, the system 10 embeds the user's pin number (step 150) into the message header, together with a new transaction identifier. The web server 12 uses the new transaction identifier to determine whether a transaction is public or private. Only new transactions contain this identifier. Responses to existing transactions contain the pin numbers of the client 22 and the prospect 21, thereby limiting access to the private bulletin board 24.

Then, the system 10 posts the new transaction (step 152) to the public bulletin board 23. As previously discussed with respect to FIG. 5, the web server then provides choices of marketing options (step 154). In addition, the system 10 automatically generate e-mails to market the transaction (step 156) to other users on the web server 12.

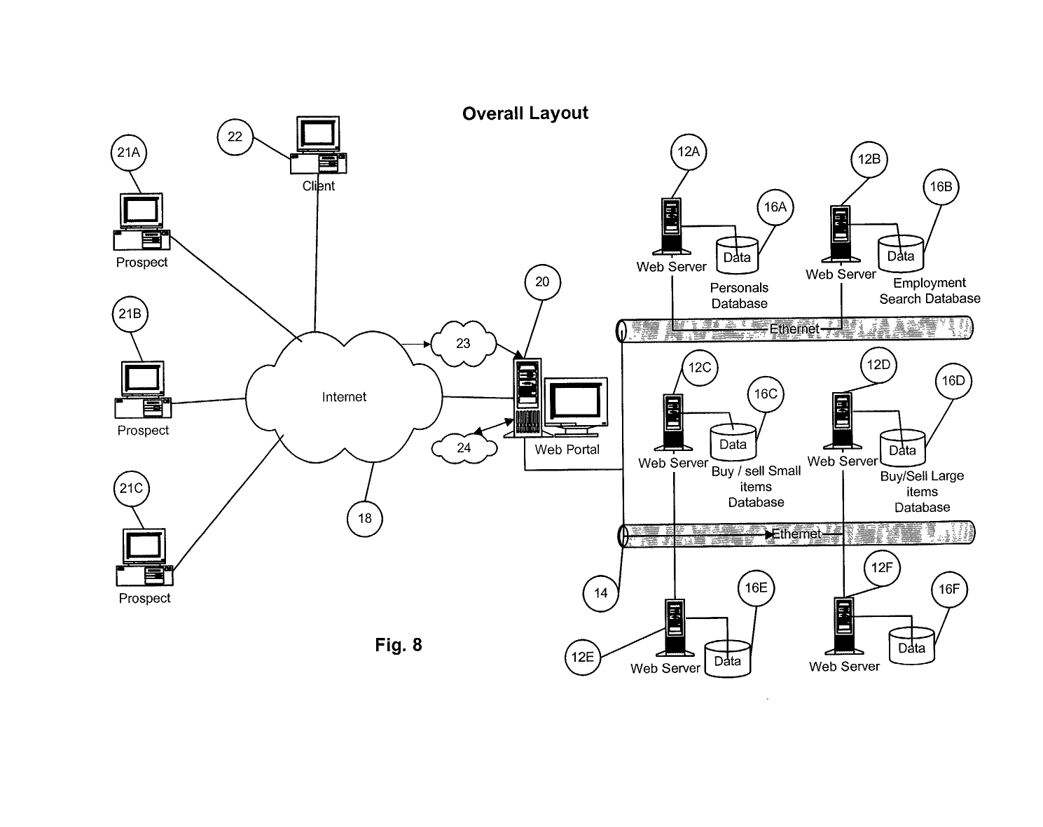

As shown in FIG. 8, the transactional system 10 may be comprised of multiple back end web servers 12A, 12B, 12C, 12D, 12E, 12F, each having their own data store 16A, 16B, 16C, 16D, 16E, 16F. Each web server 12A, 12B, 12C, 12D, 12E, 12F is connected to the Internet 18 via the web portal 20. In an alternative embodiment, each web server 12A, 12B, 12C, 12D, 12E, 12F may be connected to the Internet 18 via a dedicated web portal 20. Multiple prospects 24A, 24B, 24C and multiple clients 22 may interact with any of the web servers 12A, 12B, 12C, 12D, 12E, 12F at the same time. The web portal 20 provides a security interface for protecting the web servers 12A, 12B, 12C, 12D, 12E, 12F from unauthorized access.

Each web server 12A, 12B, 12C, 12D, 12E, 12F may be dedicated to a specific type of transaction. For instance, the web servers 12A, 12B, 12C, 12D, 12E, 12F may store transactional information and serve web pages for an employment database 16B, a personal ads database 16A, a small items database 16C, or a large items database 16D, and so on. Each web server 12A, 12B, 12C, 12D, 12E, 12F contains its own data store or database 16A, 16B, 16C, 16D, 16E, 16F of account information for the clients 22 and the prospects 21A, 21B, 21C. Thus, web server 12A and its data store 16A contain records for a clients 22, who register for the personals services or dating service. The web server 12A also stores the account information and responses from prospect 21A in the same data store 16A for the web server 12A.

The system 10 may monitor the category of transaction, such that a monetary transaction can be routed to the appropriate web server 12. If the client 22 attempts to post an advertisement for the sale of a stereo to web server 12A, the web server 12A can reroute the transaction to the appropriate server.

In one embodiment, the web server 12 will notify the client 22 that this type of posting is inappropriate for the particular server. It will provide a reason why a different server is more appropriate. It will identify which server is more appropriate and provide the URL or web address for that server, and it will replicate the user's information in the database for the appropriate server before rerouting the user to the server for entering their information. Since each web server creates its own unique pin number for the client 22, a new pin number will be created for the client 22 on the other web server 12. In the preferred embodiment, since the user has already been validated by the system 10, the system 10 may simply replicate the user account on the appropriate server.

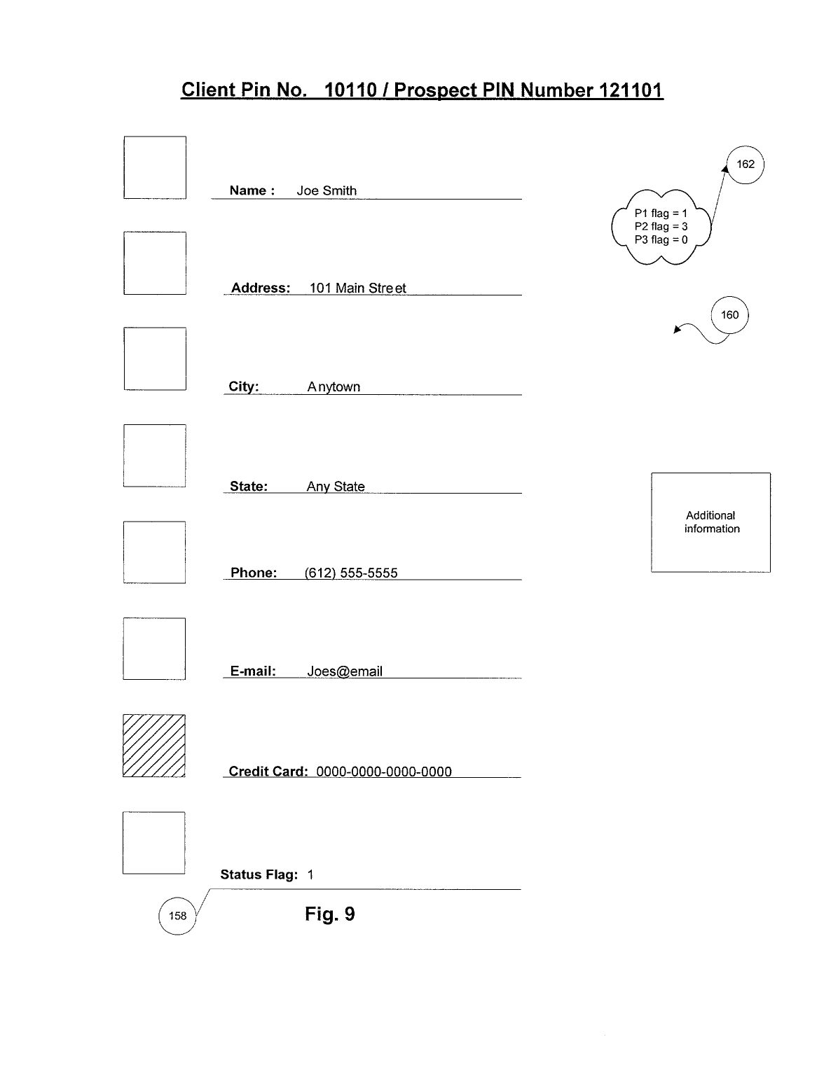

FIG. 9 illustrates an aspect of the present invention wherein a status flag 158 is maintained relative to the interaction of each client 22 and prospect 21. Within the client record for “Joe Smith” shown, multiple status flags 158 are shown. Each status flag 158 corresponds to the interaction between Joe Smith and prospect 121101, such that the status flag 158 maybe different for each interaction. The name, address, city, state, telephone number, e-mail address, credit card number and additional information are stored in a main record 160 in the data store 16 associated with each client 22. The status flags 158 are stored in linked records 162 in the data store 16. Each piece of information in the data store 16 may be revealed separately. The system 10 of the present invention anticipates that users may wish to gradually reveal their identifying information.

As shown in FIG. 9, the client 22 has authorized the disclosure of his name information to the prospect 21 corresponding to pin 121101. Checked box 164 shows that the name has been revealed. The checked box 164 corresponds to the status flag 158, such that if the address information were revealed, the status flag 158 would change to another value. Once information has been revealed to the prospect, the client cannot recall that information. Thus, the status flag 158 changes permanently as to that prospect 21.

When a message is posted to the web server 12 and the privacy agent 14 detects a disclosure, the user is warned and an authorization is required (as shown in FIGS. 6 and 7).

Authorizing the disclosure of identifying information will result in a change in the privacy status. Thus, if the client 22 authorizes the revelation of his name to the prospect 21, the revelation may not be withdrawn and the status flag 158 changes to 1.

If the client 22 subsequently types his name in a message to the prospect 21, the privacy agent 14 will not warn the client 22 about the disclosure. The system 10 adjusts the status flag 158 only in relation to a specific correspondent. Thus, a user may not globally change their privacy status, but may only change their privacy status relative to an on-going negotiation.

There may be multiple status flags 158 associated with each client 22, each status flag 158 being associated with one prospect 21. Thus, “p1” may represent “prospect 1” in the system 10, having a status flag of “1”. In this instance, a status flag of “1” means that the client 22 has opted to reveal his name information (i.e. “Joe Smith”). This status cannot be reversed, once a message has been sent and viewed.

In an alternative embodiment, the system 10 may permit a user to retract a message. If the system 10 permits this option, the status flag 158 may not be adjusted until after a message is viewed by the recipient, thereby allowing the status change and the message to be retracted by the sender before it is viewed by the recipient. However, once the prospect 21 has viewed the message, the system 10 will not allow the status flag 158 to be changed back because a disclosure has already taken place.

The default status flag 158 value is zero (“0”), meaning that no identifying information is to be revealed. The credit card information is shown by way of illustration, but the box is illustrated as being “grayed-out” because the system 10 will not permit disclosure of the credit card number.

At each instance where the user is warned, but chooses to reveal the information, the system 10 alters the status of the information and changes the status flag 158 to reflect the change. Thus, subsequent disclosures of the same information will not again trigger the warning.

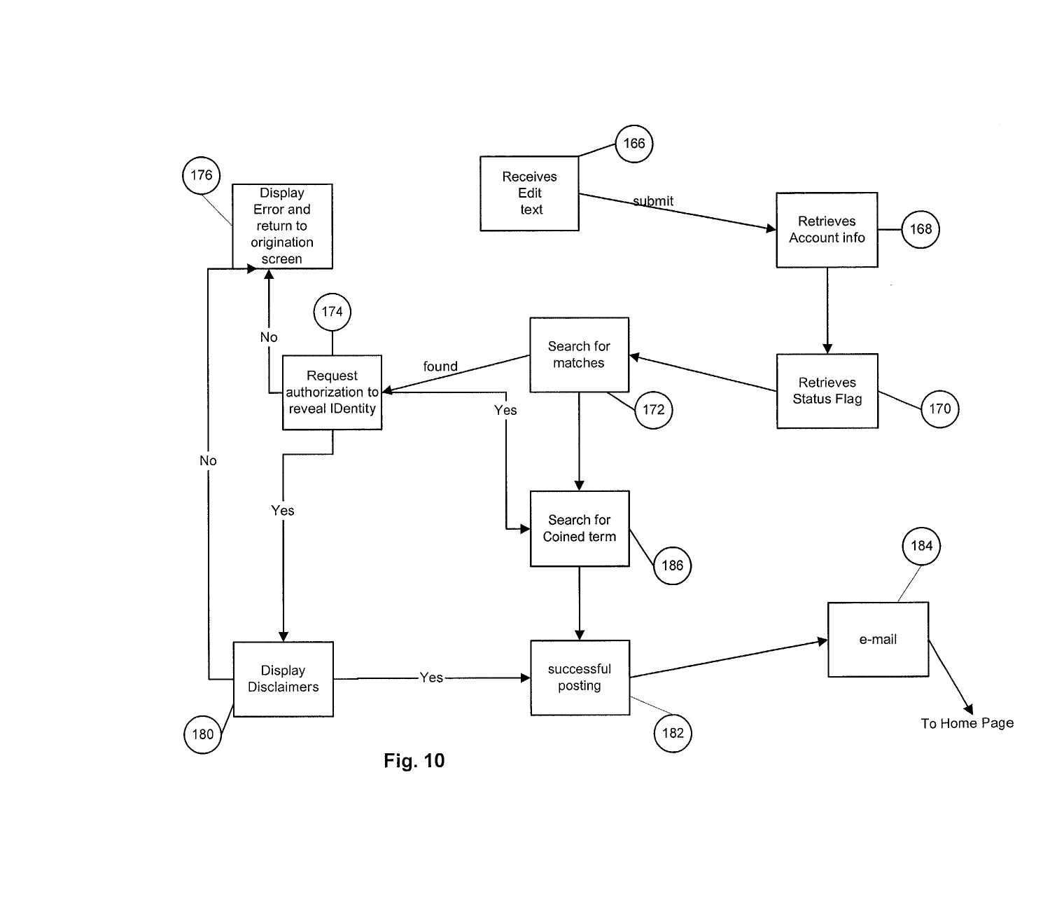

As shown in FIG. 10, the privacy agent 14 may use the status flag 158 to simplify its operation. When the privacy agent 14 receives the text message (step 166), the privacy agent 14 retrieves the account information (step 168) and retrieves the privacy status (step 170) represented by the status flag 158.

If the status flag 158 permits disclosure of a piece of information, the privacy agent 14 will not compare the message text against that piece of information. Further, by comparing the message text against information contained in the account information, the number of “false positives” will be reduced by requiring a correlation between the “offending” message text and actual identifying information.

The privacy agent 14 searches the message text for matches with the account information (step 172). If a match is found between the private account data and the message text that has not already been revealed according to the status flag 158, the web server 12 displays an authorization request (step 174). If the client does not wish to reveal identifying information, the web server 12 displays an error page (step 176) and then returns the user to the origination page (step 178). If the user authorizes disclosure of identifying information, the web server 12 displays legal disclaimers (step 180). If the user wishes not to proceed, the web server 12 displays the error page (step 176) and the user is returned to the origination page (step 178). If the user still wishes to proceed, the web server 12 posts the message (step 182), and the system 10 notifies the intended recipient (step 184).

If searching for matches (step 172) reveals none, the system 10 searches for “coined” telephone numbers (step 186) by spell checking and looking for hyphenated words. If “coined” phone numbers are detected, the web server 12 requests authorization (step 174) and displays an error message (step 176) or proceeds with the disclaimers (step 180).

If no “coined” telephone numbers are detected, the web server 12 posts the message (step 182) and notifies the intended recipient 184 before returning the user to the home page of the web site.

The disclosure of identifying information can happen in a variety of different ways. In one embodiment, once the client 22 chooses to reveal a specific field or other information about themselves to the prospect 21, the client 22 is free to enter that information in the message body and post it to the bulletin board, and the privacy agent 14 will allow that information to pass through and be posted.

In an alternative embodiment, the privacy agent 14 can proactively delete identifying information from the text of the message. The remainder of the message can then be posted to the site.

In a preferred embodiment, e-mail notices sent to either the client 22 or the prospect 21 contain a hypertext link that will bypass the initial login screen and proceed directly to the new message. The hypertext link can contain embedded user information to allow a direct connection to the posted messages without jeopardizing the security of the system 10. Thus, the system 10 may facilitate client 22/prospect 21 interaction.

While disclosure of identifying information maybe effected unilaterally, in the preferred embodiment, the system 10 will not permit unilateral disclosure. The status flag will represent the highest level that parties have permitted to be disclosed. In other words, if the client 22 authorizes the revelation of his name and his address (i.e. status flag=“2”), but the prospect 21 only authorizes the revelation of his name, the privacy agent 14 will only allow disclosure of the party's names. This “quid pro quo” approach does not permit either party to gain the upper hand by being given access to more information than the other.

Since the transactional system 10 validates the actual identities of both parties to the transaction, the gradual revelation of identifying information can be controlled. Requiring both parties to reveal the same level of information at the same time has the additional benefit of verifying that both parties are prepared to move to the next level in their negotiations.

In a personals web server 12 situation, it prevents one party from revealing too much information about themselves before they learn information about the other party. Thus, a client 22 or a prospect 21 cannot be exposed to a stalker before they know the identity of the person with whom they are communicating. Of course, a person who illegally and fraudulently assumes the identity of another for purposes of circumventing the validation of the anonymous transactional system 10 may not be stopped by any privacy agent 14. However, all efforts are made to verify the identity of the user.

The gradual revelation of identifying information about either the prospect 21 or the client 22 can be handled in number of different ways. In one embodiment, when a client 22 wishes to reveal information about themselves, that information is permitted to pass through in the posted message. In another embodiment, when a user a prospect 21 or a client 22 wishes to reveal information about themselves, they must select that information in the preferences to allow the privacy agent 14 to pass it through in the next message posted. In still in another embodiment, when a party wishes to reveal information about themselves, a email will be generated to the other party indicating that the other party wishes to reveal information about themselves. The client 22 wishing to reveal that information, for instance, would cause the system 10 to generate an email to the prospect 21 notifying the prospect 21 of the wishes of client 22. The system 10 will not notify the prospect 21 of the level of information that the client 22 is interested in revealing. Thus the prospect 21 is free to return to the website and specify a level that he/she is interested in revealing. In this embodiment, the system 10 will not permit revelation of information beyond the highest level allowed by either party.

The status flag may also be used to indicate how much information a specific party to the transaction has authorized. In the instance where each party may unilaterally disclose information, the status flag can simplify the server interaction by limiting the number of comparisons and by limiting the number of warnings.

In an alternative embodiment, the privacy agent 14 simply removes identifying information, and notifies the sender that the information has been removed. Specifically, the privacy agent 14 can edit out phone numbers, addresses, and name information to prevent inadvertent disclosure of personal identification Thus, privacy is maintained without the warnings. However, warnings are preferred over this method because permitting the privacy agent 14 to unilaterally edit the message may alter the meaning or make the message unintelligible.

The account information and privacy flag may be retrieved at any point in the process. However, in the preferred embodiment, the privacy flag and account information are retrieved early in the process so as to limit the sending of error messages, when in fact the system 10 is authorized to allow such information.

Initially, all user information entered by either the client 22 or the prospect 21 is kept at the highest level of security, meaning, that no disclosure of the information is permitted. In the preferred embodiment, when the user registers on the site, the user will be asked for any nicknames by which the user is referred or which the user has adopted. The privacy agent 14 may also use this nickname information to prevent inadvertent disclosure of name information.

In one embodiment, when the client 22 chooses to reveal his or her information, their identifying information is revealed in total. In the preferred embodiment, the client 22 may choose to reveal only a portion of the information such as a first name, and or a last name. Similarly, the prospect 21 can choose to reveal identifying information about himself or herself. Thus, privacy of the identity of the clients 22 and the prospects 21 can remain anonymous through multiple transactions between the parties on the server. Each of their posted messages remain private between themselves, and their identities remain private until they wish to reveal information. The privacy agent 14 serves as a automated safety feature to prevent inadvertent disclosure. Certainly, a individual circumventing the privacy agent 14 could cleverly determine ways to spell out their phone number or weave the phone number in a cryptic message to circumvent the privacy agent 14, but premature, inadvertent disclosures of personal information may be automatically prevented.

In a dating scenario, for instance, after initial postings, the client 22 or the prospect 21 may wish to reveal information about themselves. For instance, the client 22 may wish to reveal a first name to the prospect 21. In the preferred embodiment, neither party will be permitted to reveal more information than the other. The status flag 158 may be used to ensure that revelation of identifying information is allowed only to the level that both parties have authorized. In this embodiment, when a client 22 authorizes disclosure of information, the prospect 21 will be notified that the client 22 wishes to reveal information and will be asked if the prospect wishes to reciprocate. If so, the information will be revealed to both parties at the same level. Thus, if the client 22 wishes to reveal the name and address information, but the prospect 21 only wishes to reveal the name information, then only the name information will be revealed, maintaining the privacy status at the highest level that both parties have authorized.

Finally, though the invention is described with respect to e-mail communications and web browser interaction over the Internet 18, the transactional system 10 is capable of sending notice messages via telephone, wireless transmission, facsimile and any other communication means. In addition, with the advent of wireless e-mail, the system 10 may be configured to present an interface for dial-up, cellular or digital telephone interaction wherein voice-recognition software transcribes the messages into text.

For example, an Internet user accesses the web portal 20 by typing a domain name or URL (i.e. www.amiyourtype.com, etc.). The web server 12 displays a web page with multiple options, including logging into the system 10, registering, browsing transactions, searching transactions, creating a new transaction, etc. If the Internet user chooses “registering”, the web server 12 directs the Internet user to the registration process shown in FIG. 2. If the Internet user chooses “browsing” or “searching”, the web server 12 directs the Internet user to the public bulletin board 23 and displays transactions and a search option. If the Internet user chooses to “log in”, the web server 12 directs the user to the log in sequence depicted in FIG. 3.

Anonymity and control of the revelation of information are major advantages in the present invention. Since the system 10 prevents unauthorized or inadvertent disclosures of identifying information using the privacy agent 14, the user can control the revelation of identifying information. Since new transactions are posted to a public bulletin board 23 and subsequent messages are posted to private bulletin boards 24, new transactions may attract multiple prospects 22. All client 22 and prospect 21 communications remain private between that client 22 and that prospect 21 on the private bulletin board 24. Thus, a client 22 may conduct multiple negotiations with multiple prospects 22 at the same time, while each prospect 21 remains unaware of the others. Furthermore, the public bulletin board 23 continues to show the transaction even after the client 22 begins negotiations, potentially attracting even more prospects 22.

Finally, the client 22 can reveal selected information to each prospect 21. Since the private bulletin board 24 is specific to the client 22 and prospect 2l, each on-going negotiation may involve different levels of revealed information. Thus, the client 22 may reveal his name to one prospect 21, and no information to another prospect 21 with respect to the same posted transaction.

Although the present invention has been described with reference to preferred embodiments, workers skilled in the art will recognize that changes may be made in form and detail without departing from the spirit and scope of the invention.

1. A system for anonymous Internet transactions, the system comprising:
a web portal, the web portal having a connection with the Internet;
a plurality of web servers for hosting transactions between users, each web server in network communication with the web portal;
a plurality of data stores for storing the transactions wherein a data store is associated with each web server; and
a privacy agent for programmatically maintaining transactional anonymity between users on the web servers

2. The system of claim 1, wherein the privacy agent comprises:
a software component stored on a computer, the software agent being in network communication with each web server, the software agent programmatically monitoring text messages between the web portal and the web servers.

3. The system of claim 2, wherein the privacy agent further comprises:
privacy rules for identifying private data within the text messages, the privacy agent programmatically interfering with text messages that contain the private data according to the privacy rules.

4. The system of claim 3, wherein programmatically interfering with text messages includes temporarily preventing a message from reaching the web servers until a sender of the message authorizes disclosure of the private data.

5. The system of claim 1, wherein the plurality of data stores comprise:
a plurality of databases for storing records associated with users on the web server, each database being associated with one of the plurality of data stores.

6. The system of claim 5, wherein the records contain information about users, each record having information about one user, the information comprising:
an actual identity of the one user, the actual identity of the one user being validated by a credit card transaction;
privacy preferences associated with the one user, the privacy preferences for controlling revelation of the actual identity of the one user;
messages generated by the one user; and
a preferred contact method for the one user, the preferred contact method being used by the system to automatically send notices to each user.

7. The system of claim 6, wherein the actual identity comprises a name, a mailing address, city, state, e-mail address, and telephone numbers, wherein the privacy preferences permit the one user to gradually reveal the actual identity to another user such that the one user may reveal the name to another user without disclosing other information.

8. A method for protecting users from inadvertent disclosure of identifying information on a computer bulletin board, the method comprising:
monitoring text message transmissions programmatically using a privacy agent, the privacy agent residing on a computer network with a web server that hosts the computer bulletin board;
scanning the text message for identifying information; and
interfering temporarily with transmission of the text message if the text message contains identifying information regarding an actual identity of a sender of the text message.

9. The method of claim 8, wherein interfering temporarily with transmission comprises:
warning the sender that the text message contains identifying information;
prompting the sender to authorize disclosure of the identifying information;
processing the text message by posting the text message to the web server if the sender authorizes the disclosure or rejecting the text message if the sender fails to authorize the disclosure.

10. The method of claim 8, and further comprising:
posting the text message to a private area on the web server;
notifying an intended recipient that the text message has been posted.

11. The method of claim 10, wherein notifying an intended recipient comprises:
determining programmatically to whom the sender intends to send the text message;
retrieving a preferred contact method for the intended recipient, the preferred contact method specifying a means for contacting the intended recipient; and
notifying the intended recipient of the text message programmatically using the preferred contact method.

12. A method for allowing anonymous Internet negotiations, the method comprising:
prompting a user on a web server to establish an account on the web server;
validating an actual identity of the user before registering the user and creating the account on the web server;
allowing the registered user to submit transactional information to the web site;
monitoring the transactional information programmatically using a privacy agent; and
interfering temporarily with transmission of the transactional information if the privacy agent detects information corresponding to the actual identity of the registered user.

13. The method of claim 12, and further comprising:
transmitting the transactional information to the web server for storing in a data store; and
providing marketing opportunities to the registered user, the marketing opportunities including stickers, flyers, and e-mail to other registered users.

14. The method of claim 13, wherein providing marketing opportunities comprises:
offering the registered user a choice of marketing opportunities;
offering the registered user an option of marketing the transactional information or of having the system distribute marketing materials to attract Internet users to the transactional information; and
processing the choice and the option by preparing marketing materials and mailing the marketing materials to the registered user, and if the registered user chooses, displaying marketing materials on behalf of the registered user.

15. The method of claim 12, and further comprising;
permitting a second user to view the transactional information over the Internet;
requiring the second user to establish an account on the web server before permitting the second user to respond to the transactional information, the second user being required to enter information including a credit card number to establish an account, the information including an actual identity of the second user;
validating the actual identity of the second user according to the credit card number;
permitting the second user to post a response, the response being associated with the transactional information;
monitoring the response programmatically using a privacy agent; and
interfering temporarily with transmission of the response if the privacy agent detects information corresponding to the actual identity of the second user.

16. The method of claim 15, wherein interfering temporarily with the transmission of the response comprises:
scanning the response for text corresponding to the actual identity of the second user; and
processing the response by posting the response to the web server if no text corresponding to the actual identity of the second user is found or requiring the second user to authorize disclosure of the text corresponding to the actual identity of the second user.

17. The method of claim 12, wherein monitoring the transactional information programmatically comprises:
scanning text of the transactional information for phone numbers, addresses, names, e-mail addresses, and cities corresponding to the actual identity of the user.

18. The method of claim 15, wherein monitoring the transactional information programmatically comprises:
scanning text of the response for phone numbers, addresses, names, email addresses, and cities corresponding to the actual identity of the second user.

19. The method of claim 12, and further comprising:
generating automatically a pin number for the user, the pin number serving as a pseudonym for the user on the web server.

20. The method of claim 15, and further comprising:
generating automatically a pin number for the second user, the pin number serving as a pseudonym for the second user on the web server.
